(19) United States
(12) Patent Application Publication
(10) Pub. No.: US 2004/0021418 A1
(43) Pub. Date: Feb. 5, 2004

(54) High pressure mercury lamp and lamp unit

(76) Inventors: Kiyoshi Takahashi, Kyoto (JP); Shinichiro Hataoka, Osaka (JP); Makoto Horiuchi, Nara (JP); Makoto Kai, Osaka (JP); Tsuyoshi Ichibakase, Osaka (JP); Tomoyuki Seki, Osaka (JP); Yuriko Kaneko, Nara (JP)

Correspondence Address: HARNESS, DICKEY & PIERCE, P.L.C., P.O. BOX 828, BLOOMFIELD HILLS, MI, 48303, US

(21) Appl. No.: 10/600,045

(22) Filed: Jun. 20, 2003

(30) Foreign Application Priority Data
Jun. 26, 2002 (JP) 2002-186511

(51) Int. Cl. H01J 17/16; H01J 61/35

(52) U.S. Cl. 313/635

(57) ABSTRACT

A high pressure mercury lamp includes a luminous bulb in which at least mercury is enclosed inside the bulb, and a pair of sealing portions that retain airtightness of the luminous bulb. The amount of the enclosed mercury is 230 mg/cm³ or more based on the volume of the luminous bulb, and heat-retaining means for retaining beat in the luminous bulb is provided. Thus, the present invention can suppress blackening of high pressure mercury lamps having a very high operating pressure.

### BACKGROUND OF THE INVENTION

The present invention relates to a high pressure mercury lamp and a lamp unit. In particular, the present invention relates to a high pressure mercury lamp enclosing a comparatively large amount of mercury among high pressure mercury lamps used as a light source of projectors or the like.

In recent years, as a system realizing a large scale screen images, image projecting apparatuses such as liquid crystal projectors or DMD projectors have been widely used. As such an image projecting apparatus, a high pressure mercury lamp as disclosed in Japanese Laid-Open Patent Publication No. 2-148561 is commonly used in a wide range.

FIG. 1 shows the structure of the high pressure mercury lamp disclosed in Japanese Laid-Open Patent Publication No. 2-148561. A lamp 1000 shown in FIG. 1 includes a luminous bulb 1 mainly made of quartz glass, and a pair of side tube portions (sealing portions) 2 extending from both ends thereof. Metal electrode structures are buried in the side tube portions 2 so that power can be supplied to the luminous bulb from the outside. The electrode structure has a structure in which an electrode 3 made of tungsten (W), a molybdenum (Mo) foil 4, and an external lead wire 5 are electrically connected sequentially in this order. A coil 12 is wound around the head of the electrode 3. In the luminous bulb 1, mercury (Hg), which is a luminous species, argon (Ar) and a small amount of halogen gas (not shown) are enclosed.

The operational principle of the lamp 1000 will be described. When a start voltage is applied to both ends of the pair of external lead wires 5, discharge of Ar occurs, and the temperature in the luminous bulb 1 increases. With this increase of the temperature, Hg atoms evaporate and fill the luminous bulb 1 in the form of gas. The Hg atoms are excited by electrons released from one electrode 3 and become luminous between the two electrodes 3. Therefore, as the vapor pressure of Hg, which is the luminous species, is higher, light having a higher intensity is released. Furthermore, as the vapor pressure of Hg is higher, the potential difference (voltage) between the two electrodes is larger, so that current can be reduced when the lamp is operated with the same rated power. This means that a burden to the electrode 3 can be reduced, which leads to a longer lifetime of the lamp. Therefore, as the Hg vapor pressure is larger, a lamp having better characteristics in terms of the intensity and the lifetime can be obtained.

However, in view of the physical strength against pressure, a conventional high pressure mercury lamp is operated at a Hg vapor pressure of about 15 to 20 MPa (150 to 200 atm) in a practical use. Japanese Laid-Open Patent Publication No. 2-148561 discloses a superhigh pressure mercury lamp used at a Hg vapor pressure of 200 bar to 350 bar (equivalent to about 20 MPa to about 35 MPa), but in a realistic use in view of the reliability and the lifetime or the like, the lamp is used at a Hg vapor pressure of about 15 MPa to 20 MPa (150 to 200 atm).

Although research and development are performed to increase the strength against pressure, a high pressure mercury lamp that can withstand a high pressure such as a Hg vapor of more than 20 MPa in practical use has not been reported yet at present. In this context, the inventors of the present invention succeeded in completing a high pressure mercury lamp that can withstand high pressure such as a Hg vapor of about 30 to 40 MPa or more (about 300 to 400 atm or more) and disclosed Patent Applications Nos. 2001-267487 and 2001-371365.

This high pressure mercury lamp having a very high withstand pressure is operated at a high mercury vapor pressure that cannot be achieved in the conventional technique, and therefore the characteristics and the behavior cannot be predicted. When the inventors of the present invention made operation tests of the high pressure mercury lamp, it was found that the lamp is blackened when the operating pressure exceeds 20 MPa, which is the conventional operating pressure, especially reaches generally 30 MPa or more.

### SUMMARY OF THE INVENTION

Therefore, with the foregoing in mind, it is a main object of the present invention to provide a high pressure mercury lamp that is not blackened even at an operating pressure of more than 20 MPa (e.g., 23 MPa or more, particularly 25 MPa or 30 MPa or more).

A high pressure mercury lamp of the present invention includes a luminous bulb in which at least mercury is enclosed inside the bulb, and a pair of sealing portions that retain airtightness of the luminous bulb. At least one of the sealing portions has a first glass portion extending from the luminous bulb and a second glass portion provided at least in a portion inside the first glass portion, and the one of the sealing portions has a portion to which a compressive stress is applied. A heat-retaining film made of an insulating material or a beat-retaining material is provided at least in a portion of the luminous bulb and the pair of sealing portions.

In one preferable embodiment, the amount of the enclosed mercury is 230 mg/cm³ or more based on the volume of the luminous bulb.

In one preferable embodiment, the amount of the enclosed mercury is 300 mg/cm³ or more based on the volume of the luminous bulb, halogen is enclosed in the luminous bulb, and the bulb wall load of the high pressure mercury lamp is 80 W/cm² or more.

In one preferable embodiment, the heat-retaining film is not formed in the luminous bulb, and formed in at least one of the pair of sealing portions, and an end face of the heat-retaining film on the side of the luminous bulb is positioned apart from a border between the at least one of the sealing portions and the luminous bulb by 1 mm or more.

It is preferable that the end face of the heat-retaining film on the side of the luminous bulb is positioned within 10 mm from the border.

In one preferable embodiment, the heat-retaining film is made of alumina.

Another high pressure mercury lamp of the present invention includes a luminous bulb in which at least mercury is enclosed inside the bulb, and a pair of sealing portions that retain airtightness of the luminous bulb. At least one of the sealing portions has a first glass portion extending from the luminous bulb and a second glass portion provided at least in a portion inside the first glass portion, and the one of the sealing portions has a portion to which a compressive stress is applied. An outer tube made of a translucent material is provided around the luminous bulb such that the outer tube is apart from the luminous tube.

It is preferable that an infrared reflecting film is formed in the outer tube.

In one preferable embodiment, a pair of electrode rods are opposed to each other in the luminous bulb. At least one of the pair of electrode rods is connected to a metal foil. The metal foil is provided in the sealing portion. At least a portion of the metal foil is positioned in the second glass portion.

In one preferable embodiment, a coil having at least one metal selected from the group consisting of Pt, Ir, Rh, Ru, and Re at least on its surface is wound around at least in a portion of the electrode rod that is buried in the at least one of the sealing portions.

In one preferable embodiment, a metal portion that is in contact with the second glass portion and supplies power is provided in the sealing portions. The compressive stress is applied at least in a longitudinal direction of the sealing portions. The first glass portion contains 99 wt % or more of SiO₂. The second glass portion contains SiO₂ and at least one of 15 wt % or less of Al₂O₃ and 4 wt % or less of B.

Another high pressure mercury lamp of the present invention includes a luminous bulb in which at least mercury is enclosed inside the bulb and a pair of electrode rods are opposed, and a pair of sealing portions extending from the luminous bulb. A coil having at least one metal selected from the group consisting of Pt, Ir, Rh, Ru, and Re at least on its surface is wound around at least in a portion of the electrode rod that is buried in at least one of the sealing portions. A heat-retaining film made of an insulating material or a heat-retaining material is formed at least in a portion of the luminous bulb and the pair of sealing portions.

Yet another high pressure mercury lamp of the present invention includes a luminous bulb in which at least mercury is enclosed inside the bulb, and a pair of sealing portions that retain airtightness of the luminous bulb. The amount of the enclosed mercury is 230 mg/cm³ or more based on the volume of the luminous bulb. The high pressure mercury lamp further includes heat-retaining means for retaining heat in the luminous bulb.

In one preferable embodiment, the heat-retaining means is a heat-retaining film that is formed at least in a portion of the luminous bulb and the pair of sealing portions, and is made of an insulating material or a heat-retaining material.

In one preferable embodiment, the heat-retaining means is an outer tube that is provided around the luminous bulb such that the outer tube is apart from the luminous bulb, and is made of a translucent material.

In one preferable embodiment, the amount of the enclosed mercury is 300 mg/cm³ or more based on the volume of the luminous bulb, halogen is enclosed in the luminous bulb, and a bulb wall load of the high pressure mercury lamp is 80 W/cm² or more.

A high pressure mercury lamp in an embodiment includes a luminous bulb in which a pair of electrodes are opposed in the bulb, and sealing portions extending from the luminous bulb and having a portion of the electrode inside. A metal film constituted by at least one metal selected from the group consisting of Pt, Ir, Rh, Ru, and Re is formed on a surface at least in a portion of the electrode that is positioned inside the sealing portions.

In one embodiment, the electrodes are connected to the metal foils provided in the sealing portions by welding, and the metal film is not formed in the connection portion with the metal foils and is formed on the surface of the electrodes that is buried in the sealing portions. A portion of the metal constituting the metal film may be present in the luminous bulb. It is preferable that the metal film has a multilayered structure including an Au layer as the lower layer and a Pt layer as the upper layer.

A high pressure mercury lamp in an embodiment includes a luminous bulb in which a pair of electrodes are opposed in the bulb, and a pair of sealing portions extending from the luminous bulb and having a portion of the electrode inside. A coil having at least one metal selected from the group consisting of Pt, Ir, Rh, Ru, and Re on its surface is wound around a portion of the electrode that is positioned inside the sealing portions. In one embodiment, the metal foil and a portion of the electrode are buried in the sealing portions, and a coil having at least one metal selected from the group consisting of Pt, Ir, Rh, Ru, and Re on its surface is wound around the electrode that is buried in the sealing portions. It is preferable that the coil has a metal film having a multilayered structure including an Au layer as the lower layer and a Pt layer as the upper layer on its surface.

A high pressure mercury lamp in one embodiment includes a luminous bulb enclosing a luminous substance inside; and sealing portions for retaining airtightness of the luminous bulb. The sealing portion has a first glass portion extending from the luminous bulb and a second glass portion provided at least in a portion inside the first glass portion. The sealing portion has a portion to which a compressive stress is applied. The portion to which a compressive stress is applied is one selected from the group consisting of the second glass portion, a boundary portion of the second glass portion and the first glass portion, a portion of the second glass portion on the side of the first glass portion, and a portion of the first glass portion on the side of the second glass portion. In one embodiment, a strain boundary region caused by a difference in the compressive stress between the first glass portion and the second glass portion is present in the vicinity of the boundary of the two glass portions. It is preferable that a metal portion for supplying power that is in contact with the second glass portion is provided in the sealing portion. The compressive stress may be applied at least in the longitudinal direction of the sealing portion.

In one embodiment, the first glass portion contains 99 wt % or more of SiO₂, and the second glass portion contains SiO₂ and at least one of 15 wt % or less of Al₂O₃ and 4 wt % or less of B. The softening point of the second glass portion is lower than that of the first glass portion. It is preferable that the second glass portion is formed of a glass tube. It is preferable that the second glass portion is not formed by compressing and sintering glass powder. In one embodiment, the compressive stress in the portion to which the compressive stress is applied is about 10 kgf/cm² or more and about 50 kgf/cm² or less, or the difference in the compressive stress is about 10 kgf/cm² or more and about 50 kgf/cm² or less.

In one embodiment, a pair of electrode rods are opposed in the luminous bulb, at least one of the pair of electrode rods is connected to a metal foil, and the metal foil is provided in the sealing portion, and at least a portion of the metal foil is positioned in the second glass portion. At least mercury is enclosed in the luminous bulb as the luminous substance, and the amount of the enclosed mercury is 300 mg/cc or more. The general color rendering index Ra of the high pressure mercury lamp is more than 65. It is preferable that the color temperature of the high pressure mercury lamp is 8000 K or more.

A lamp unit of the present invention includes a high pressure mercury lamp and a reflecting mirror for reflecting light emitted from the high pressure mercury lamp. The high pressure mercury lamp includes a luminous bulb in which at least mercury is enclosed inside the bulb, and a pair of sealing portions that retain airtightness of the luminous bulb. The amount of the enclosed mercury is 230 mg/cm³ or more based on the volume of the luminous bulb, and heat-retaining means for retaining heat in the luminous bulb is provided.

In one embodiment, the heat-retaining means is a heat-retaining film that is formed at least in a portion of the luminous bulb and the pair of sealing portions, and is made of an insulating material or a heat-retaining material.

In one embodiment, the reflecting mirror is an ellipsoidal or paraboloidal reflecting mirror having a front opening in the emission direction, a front glass is provided in the front opening, the inside of the reflecting mirror is substantially airtight, and the reflecting mirror serves as the heat-retaining means.

In one embodiment, the amount of the enclosed mercury is 300 mg/cm³ or more based on the volume of the luminous bulb, halogen is enclosed in the luminous bulb, and a bulb wall load of the high pressure mercury lamp is 80 W/cm² or more.

In one embodiment, the reflecting mirror has a structure in which the side face of the reflecting mirror is not provided with a ventilation hole, the size of a radiation surface of the reflecting mirror is 25 cm² or less, and the wattage of the high pressure mercury lamp during steady operation is 60 W or more and 120 W or less.

In one embodiment, the reflecting mirror has a structure in which the side face of the reflecting mirror is not provided with a ventilation hole, the size of a radiation surface of the reflecting mirror is 40 cm² or less, and the wattage of the high pressure mercury lamp during steady operation is 121 W or more and 200 W or less.

In one embodiment, the reflecting mirror has a structure in which the side face of the reflecting mirror is not provided with a ventilation hole, the size of a radiation surface of the reflecting mirror is 55 cm² or less, and the wattage of the high pressure mercury lamp during steady operation is 201 W or more and 350 W or less.

A lamp unit in one embodiment includes a high pressure mercury lamp and a reflecting mirror for reflecting light emitted from the high pressure mercury lamp. The high pressure mercury lamp includes a luminous bulb in which at least mercury is enclosed inside the bulb, and a pair of sealing portions that retain airtightness of the luminous bulb. At least one of the sealing portions has a first glass portion extending from the luminous bulb and a second glass portion provided at least in a portion inside the first glass portion, and the one of the sealing portions has a portion to which a compressive stress is applied. A heat-retaining film made of an insulating material or a heat-retaining material is provided at least in a portion of the luminous bulb and the pair of sealing portions. In one embodiment, the amount of the enclosed mercury is 230 mg/cm³ or more based on the volume of the luminous bulb.

### BRIEF DESCRIPTION OF THE DRAWINGS

FIG. 1 is a schematic view showing the structure of the conventional high pressure mercury lamp 1000.

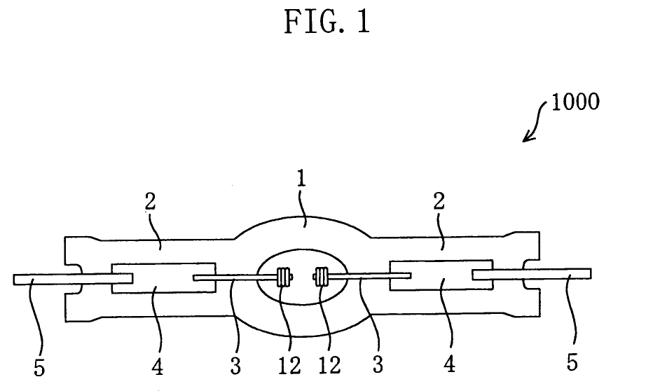

FIGS. 2A and 2B are schematic views showing the structure of a high pressure mercury lamp 1100.

FIG. 3 is a schematic view showing the structure of a high pressure mercury lamp 1200.

FIG. 4 is a schematic view showing the structure of a high pressure mercury lamp 1300.

FIG. 5A is a schematic view showing the structure of a high pressure mercury lamp 1400, and FIG. 5B is a schematic view showing the structure of a high pressure mercury lamp 1500.

FIG. 6 is a schematic view showing the structure of a high pressure mercury lamp 100 of an embodiment of the present invention.

FIG. 7 is a graph showing the optical spectrum of lamps having operating pressures of 20 MPa and 40 MPa.

FIG. 8 is a schematic view of a lamp for illustrating the temperature distribution of a luminous bulb during operation.

FIG. 9 is a variation example of the high pressure mercury lamp 100 when the lamp is operated vertically.

FIG. 10 is a schematic view showing the structure of the high pressure mercury lamp 200 of Embodiment 2 of the present invention.

FIG. 11 is a schematic view showing the structure of a lamp 300 provided with a reflecting mirror of Embodiment 3 of the present invention.

### DETAILED DESCRIPTION OF THE INVENTION

First, before describing embodiments of the present invention, a high pressure mercury lamp that can withstand a very high pressure such as an operating pressure of about 30 to 40 MPa or more (about 300 to 400 atm or more) will be described. The details of such a high pressure mercury lamp are disclosed in Patent Application Nos. 2001-267487 and 2001-371365, which are incorporated herein by reference.

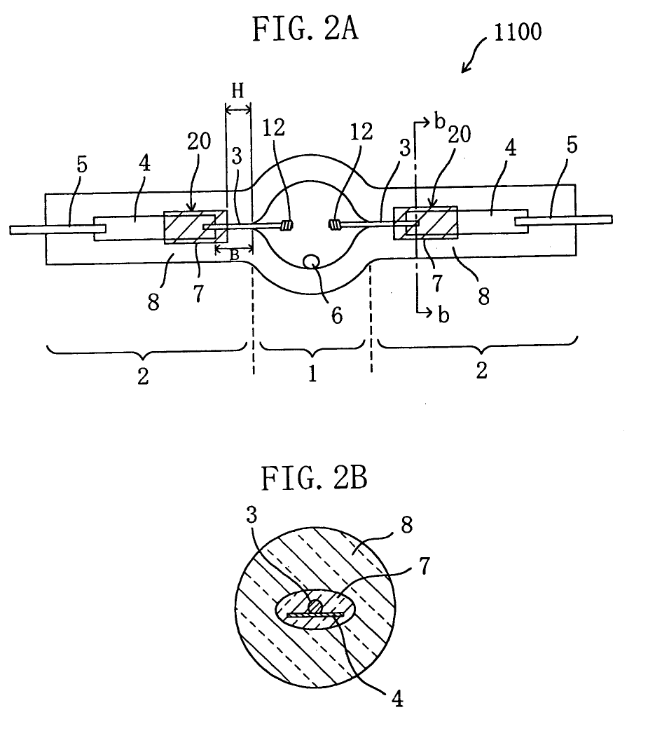

It was very difficult to develop a high pressure mercury lamp that can withstand an operating pressure of about 30 MPa or more in practical use, but for example, with the structure shown in FIG. 2, a lamp having a very high withstand pressure was completed successfully. FIG. 2B is a cross-sectional view taken along line b-b in FIG. 2A.

The high pressure mercury lamp 1100 shown in FIG. 2 is disclosed in Patent Application No. 2001-371365, and includes a luminous bulb 1 and a pair of sealing portions 2 for retaining the airtightness of the luminous bulb 1. At least one of the sealing portions 2 has a first glass portion 8 extending from the luminous bulb 1 and a second glass portion 7 provided at least in a portion inside of the first glass portion 8, and the one sealing portion 2 has a portion (20) in which a compression stress is applied.

The first glass portion 8 in the sealing portion 2 contains at least 99 wt % of SiO₂, and is made of quartz glass, for example. On the other hand, the second glass portion 7 contains SiO₂ and at least one of 15 wt % or less of Al₂O₃ and 4 wt % or less of B, and is made of Vycor glass, for example. When Al₂O₃ or B is added to SiO₂, the softening point of the glass is decreased, so that the softening point of the second glass portion 7 is lower than that of the first glass portion 8. It should be noted that Vycor glass (product name) is glass that has better processability than that of quartz glass by mixing an additive to quartz glass so as to decrease the softening point. The composition thereof is, for example, 96.5 wt % of silica (SiO₂), 0.5 wt % of alumina (Al₂O₃) and 3 wt % of boron (B). In this embodiment, the second portion 7 is formed of a glass tube made of Vycor glass. Instead of the glass tube made of Vycor glass, a glass tube containing 62 wt % of SiO₂, 13.8 wt % of Al₂O₃ and 23.7 wt % of CuO can be used.

It is sufficient that the compression stress applied into a portion of the sealing portion 2 is substantially more than 0 (that is, 0 kgf/cm²). The presence of this compression stress can improve the strength against pressure over the conventional structure. It is preferable that the compression stress is about 10 kgf/cm² or more (about 9.8×10⁵ N/m² or more) and about 50 kgf/cm² or less (about 4.9×10⁶ N/m² or less). When it is less than 10 kgf/cm², the compression strain may be weak so that the strength against pressure of the lamp may not be increased sufficiently. The reason why the compression stress is preferably 50 kgf/cm² or less is that there is no practical glass material to realize a structure having a compression stress of more than 50 kgf/cm². However, even if the compression stress is less than 10 kgf/cm², if it substantially exceeds 0, the withstand pressure can be higher than that of the conventional structure. In addition, if a practical material that can realize a structure having a compression stress of more than 50 kgf/cm² has been developed, the second glass portion 7 can have a compression stress of more than 50 kgf/cm².

An electrode rod 3 whose one end is positioned in the discharge space is connected to a metal foil 4 provided in the sealing portion 2 by welding, and at least a portion of the metal foil 4 is positioned in the second glass portion 7. In the structure shown in FIG. 2, a portion including the connection portion of the electrode rod 3 and the metal foil 4 is covered with the second glass portion 7. The size of the second glass portion 7 in the structure shown in FIG. 2 is, for example, as follows: the length in the longitudinal direction of the sealing portion 2 is about 2 to 20 mm (e.g., 3 mm, 5 mm or 7 mm), and the thickness of the second glass portion 7 sandwiched between the first glass portion 8 and the metal foil 4 is about 0.01 to 2 mm (e.g., 0.1 mm). The distance H from the end face of the second glass portion 7 on the luminous bulb 1 side to the discharge space of the luminous bulb 1 is, for example, 0 mm to about 3 mm. The distance B from the end face of the metal foil 4 on the luminous bulb 1 side to the discharge space of the luminous bulb 1 (in other words, the length in which the electrode rod 3 alone is buried in the sealing portion 2) is, for example, about 3 mm.

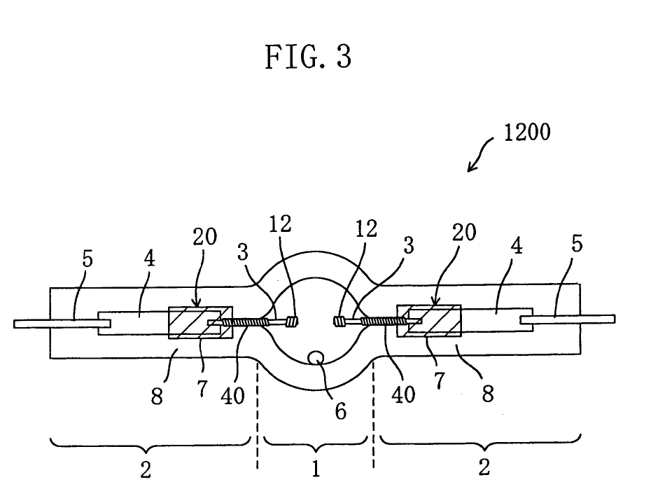

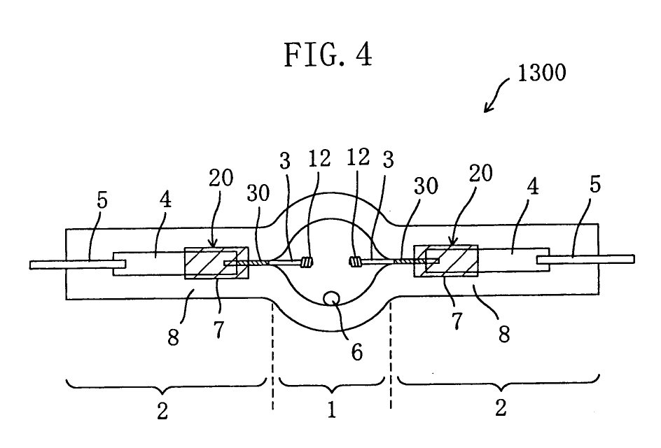

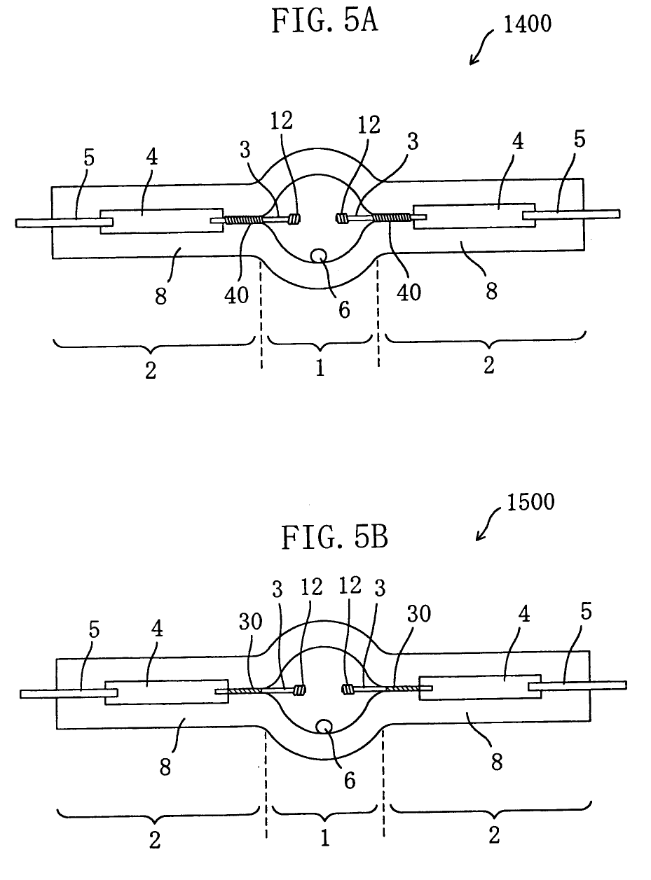

The lamp 1100 shown in FIG. 2 can be modified as shown in FIG. 3. A high pressure mercury lamp 1200 shown in FIG. 3 has a structure in which a coil 40 having a metal of at least one selected from the group consisting of Pt, Ir, Rh, Ru, and Re on its surface is wound around the portion of the electrode 3 that is positioned in the sealing portion 2. In this embodiment, the coil 40 typically has a metal film having a multilayered structure of an Au layer as the lower layer and a Pt layer as the upper layer on its surface. Instead of the coil 40, a metal film 30 formed of at least one selected from the group consisting of Pt, Ir, Rh, Ru, and Re is formed on the surface of at least a portion of the electrode 3 that is positioned in the sealing portion 2, as shown in the high pressure mercury lamp 1300 shown in FIG. 4, which may be somewhat a disadvantage in production process in mass production. High pressure mercury lamps 1400 and 1500 having structures employing the coil 40 or the metal film 30 without using the second glass portion 7, as shown in FIGS. 5A and 5B, can realize an operating pressure of 30 MPa or more in the level in which the lamp can operate in practical use, although the withstand pressure becomes lower than that of the structures shown in FIGS. 2 to 4.

A lamp in which the Hg vapor pressure during operation exceeds 30 MPa (300 atm) as shown in FIG. 2 was produced as a sample and the inventors of the present invention made operation tests. Then, it was found that when the operating pressure reaches about 30 MPa or more, the lamp is blackened. Blackening is a phenomenon that occurs when the temperature of the W electrode 3 is increased during operation and W (tungsten) evaporated from the W electrode is attached onto the inner wall of the luminous bulb, and if the lamp constitutes to be operated in this state, it will be broken.

Here, if the lamp is operated at a conventional operating pressure of about 15 to 20 MPa (150 to 200 atm), a halogen gas enclosed in the luminous bulb reacts with tungsten attached onto the inner wall of the luminous bulb to be converted into tungsten halide. The tungsten halide floats in the luminous bulb and reaches the head of the W electrode having a high temperature, the tungsten halide is dissociated into halogen and tungsten, which is the original state, so that the tungsten returns to the head of the electrode. This is referred to as “halogen cycle”. At the Hg vapor pressure of the conventional lamp, the lamp can be operated without being blackened because of this cycle. However, the experiments of the inventors of the present invention confirmed that when the operating pressure is 30 MPa (300 atm) or more, this cycle does not work well. Even if blackening becomes significant at 30 MPa or more, in order to increase the reliability in practical use, it is necessary to take measures against the blackening problem, not only in the level of 30 MPa or more, but also in the level of more than 20 MPa (e.g., the level of 23 MPa or more, or 25 MPa or more).

The inventors of the present invention found that the blackening problem can be solved by controlling the temperature of the luminous bulb 1, and achieved the present invention. Hereinafter, embodiments of the present invention will be described. However, the present invention is not limited to the following embodiments.

Embodiment 1

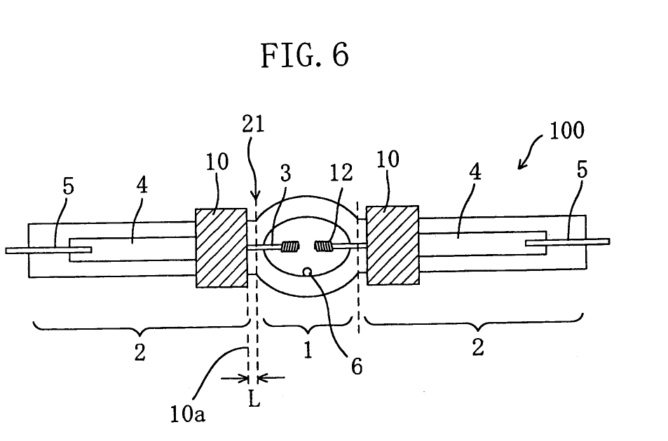

Hereinafter, embodiments of the present invention will be described with reference to the accompanying drawings. FIG. 6 shows a high pressure mercury lamp 100 having an amount of enclosed mercury 6 of 230 mg/cm³ or more. The lamp 100 of this embodiment includes heat-retaining means 10 for retaining the heat in a luminous bulb 1, and in the example shown in FIG. 6, a heat-retaining film made of a heat-insulating material or a heat-retaining material is formed as the heat-retaining means 10 at least in a portion of the luminous bulb 1 and a pair of sealing portions 2. The basic structure of the high pressure mercury lamp 100 is typically the same structure as the high pressure mercury lamps 1100 to 1500 shown in FIGS. 2 to 5A and 5B. That is, the structure is such that the heat-retaining film 10 is formed in these lamps.

The high pressure mercury lamp 100 shown in FIG. 6 includes a luminous bulb 1 enclosing at least mercury 6 inside and a pair of sealing portions 2 for retaining the airtightness of the luminous bulb 1. The amount of the enclosed mercury 6 is 230 mg/cm³ or more (e.g., 250 mg/cm³ or more or 300 mg/cm³ or more, and more than 350 mg/cm³ or 350 mg/cm³ to 400 mg/cm³ or more in some cases) based on the volume of the luminous bulb.

In the luminous bulb 1, a pair of electrodes (or electrode rods) 3 are opposed to each other, and the electrodes 3 are connected to metal foils 4 by welding. The metal foils 4 are typically molybdenum foils and are provided in the sealing portions 2. When the high pressure mercury lamp 100 is the lamp 1100 shown in FIG. 2, at least a portion of the metal foil 4 is positioned inside the second glass portion 7.

The heat-retaining film 10 as the heat-retaining means that controls the temperature of the luminous bulb 1 is made of, for example, alumina. The thickness of the heat-retaining film 10 is, for example, about 0.001 mm to 20 mm. In this embodiment, the heat-retaining film 10 is not formed in the luminous bulb 1, but in a portion of the sealing portion 2 positioned on the side of an external lead 5 from the border 21 between the sealing portion 2 and the luminous bulb 1. An end face 10a of the heat-retaining film 10 on the side of the luminous bulb 1 is positioned apart from the border 21 between the sealing portion 2 and the luminous bulb 1 by, for example, 1 mm or more. The end face 10a of the heat-retaining film 10 is positioned within 10 mm from the border 21. In other words, a distance L from the end face 10a of the heat-retaining film 10 to the border 21 is 1 mm or more and 10 mm or less (the distance L is preferably 5 mm±2 mm). This distance is preferable because if the heat-retaining film 10 is formed so as to cover the luminous bulb 1 or if the distance L is 0 mm, the luminous bulb 1 is heated excessively because of the heat-retaining film 10, so that it is highly possible that the luminous bulb 1 is expanded and broken. On the other hand, if the distance L exceeds 10 mm, for example, if the distance L is 20 mm, the capability of the heat-retaining film 10 for the function of adjusting the temperature of the luminous bulb 1 is reduced.

The structure of the lamp 100 will be described in detail. The lamp 100 includes a luminous bulb 1 made mainly of quartz and a pair of sealing portions (side tube portions) 2 extending from both ends of the luminous bulb and is a double end type lamp having two sealing portions 2. The luminous bulb 1 is substantially spherical, and the outer diameter is, for example, about 5 mm to 20 mm, the inner diameter is, for example, about 2 to 15 mm, and the thickness of the glass is, for example, about 1 mm to 5 mm. The volume of the discharge space of the luminous bulb 1 is, for example, about 0.01 cc to 1 cc (0.01 cm³ to 1 cm³). In this embodiment, the luminous bulb 1 having an outer diameter of about 10 mm, a thickness of the glass of about 3 mm, and a volume of the discharge space of the luminous bulb 1 of about 0.06 cc is used.

A pair of electrode rods 3 are opposed in the luminous bulb 1. The heads of the electrode rods 3 are provided in the luminous bulb with a distance (arc length) of about 0.2 to 5 mm. In this embodiment, the arc length is 0.5 to 1.8 mm. The lamp of this embodiment is operated with AC current. The sealing portion 2 has a shrink structure produced by a shrinking approach. In the luminous bulb 1, mercury 6, which is the luminous species, is enclosed in an amount of 300 mg/cc or more. In this embodiment, mercury is enclosed in an amount of 400 mg/cc. A rare gas (e.g., Ar) with 5 to 40 kPa and, if necessary, a small amount of halogen are enclosed. In this embodiment, Ar with 20 kPa is enclosed, and halogen is enclosed in the form of CH₂Br₂ in the luminous bulb 1. The amount of the enclosed CH₂Br₂ is about 0.0017 to 0.17 mg/cc, which corresponds to about 0.01 to 1 μmol/cc in terms of the halogen atom density during lamp operation. In this embodiment, it is about 0.1 μmol/cc. The bulb wall load applied to the inner wall of the luminous bulb during operation is, for example, 80 W/cm² or more. In this embodiment, the lamp is operated at 120 W and the bulb wall load is about 150 W/cm².

An example of the structure of the lamp 100 produced by the inventors of the present invention as a sample is as follows. The outer diameter of the luminous bulb 1 is 10 mm, the inner diameter is 4 mm, the glass thickness is 3 mm, and the internal volume is 0.06 cc. The amount of enclosed mercury is 24 mg (=400 mg/cc=pressure during operation: 40 MPa), the interelectrode distance is 0.5 mm to 1.8 mm, CH₂Br₂ as halogen is enclosed in 0.017 mg/cc corresponding to a halogen atom density of 0.1 μmol/cc, and argon as a rare gas is enclosed at 20 kPa (room temperature). The thickness of the heat-retaining film 10 is 1 mm, and the distance L is 5 mm. The length of the sealing portion 2 is about 25 mm.

In order to compare the lamp 100, lamps that are the same lamp as that shown in FIG. 6 but are not provided with the heat-retaining film 10 and have varied amounts of mercury were prepared as comparative lamps. More specifically, lamps that are the same as the lamp 1200 of FIG. 3 and have an amount of mercury of 12 mg (an operating pressure of 20 MPa), 15 mg (an operating pressure of 25 MPa), 18 mg (an operating pressure of 30 MPa), 21 mg (an operating pressure of 35 NPa), and 24 mg (an operating pressure of 40 MPa) were prepared as comparative lamps.

These lamps are operated at a rated power of 120 W for one hour in a horizontal operation, and then are turned off for 15 minutes. This operation was repeated for 5 hours. As a result, among the comparative lamps, in all the lamps operated at an operating pressure of 30 MPa or more, blackening was observed in the upper portion of the luminous bulb, and the higher the operating pressure is, the more significantly blackening appeared in the lamp. Among the comparative lamps, in all the lamps operated at an operating pressure of 25 MPa or less, blackening did not occur. This fact confirmed that blackening occurred in the high pressure mercury lamp operated at an operating pressure of 30 MPa or more.

On the other hand, when the lamp 100 of this embodiment having the heat-retaining film 10 was operated in the same manner as the comparative lamps, surprisingly, although the operating pressure was 40 MPa, blackening did not occur. Then, the amount of mercury of the lamp 100 of this embodiment was varied to 18 mg (an operating pressure of 30 MPa), 21 mg (an operating pressure of 35 MPa), 27 mg (an operating pressure of 45 MPa), and 30 mg (an operating pressure of 50 MPa), but blackening was observed in none of the lamps.

That is to say, in the comparative lamps that is not provided with the heat-retaining film 10, when the mercury operating pressure is 30 MPa or more, blackening occurred in the upper portion of the luminous bulb, whereas blackening was suppressed when the heat-retaining film 10 was provided as in the structure of the lamp 100 of this embodiment.

The fact that the lamps are blackened at an operating pressure of 30 MPa or more was found by the inventors of the present invention for the first time. This is because there is no practically usable lamp having an operating pressure of 30 MPa or more.

The reason why the lamps having an operating pressure of 30 MPa or more are blackened is not definitely clarified at present. Since no definite reason is known, the inventors of the present invention attempted various measures and modifications to prevent blackening. For example, it was confirmed that in the lamps having an operating pressure of 30 MPa or more, the temperature of the lamp (in particular, the luminous bulb) was increased more than in the lamps with 15 MPa to 20 MPa. Then, the inventors suspected that this increase might be a cause of blackening, and decreased the temperature of the luminous bulb by cooling the luminous bulb during lamp operation. However, blackening was not prevented. They made various other attempts, but blackening was not prevented well. During the experiments, based on the idea that retaining heat in the luminous bulb might work well, heat was retained by the heat-retaining film so as not to reduce the temperature of the luminous bulb. Then, to their surprise, they succeeded in preventing blackening. Inferring from this successful example, it seems that blackening is prevented for the following reason.

In the case of a so-called superhigh pressure mercury lamp, tungsten that is the material for the electrodes is evaporated by the heat radiation of the arc and heat generation of the electrodes themselves. The evaporated tungsten is carried to the bulb wall by a convection occurring in the bulb, and cooled rapidly at the bulb wall and attached thereto. Then, the attached tungsten reacts with halogen enclosed in the luminous bulb 1 and is evaporated in the form of tungsten halide from the bulb wall, and eventually the tungsten returns to the electrodes. This is referred to as “halogen cycle”.

In the case of a lamp having a comparatively low operating pressure, since the amount of tungsten evaporated is comparatively small, the amount of tungsten evaporated and the amount of tungsten that reacts with halogen and is evaporated are in equilibrium. On the other hand, when the operating pressure is increased (the amount of enclosed mercury is increased), the number of mercury atoms in the arc is increased, and the mobility of electrons released from the electrodes is decreased with the increase of the mercury atoms so that the arc is narrower. As a result, if the same power is supplied, the energy per unit volume of the arc is larger and therefore the temperature of the arc is increased. Due to this increase of the arc temperature, the temperature of the electrodes is increased, thus resulting in active evaporation of the tungsten that is the material of the electrode. In this case, since the amount of tungsten halide is unchanged, the tungsten continues to be attached onto the bulb wall, thus resulting in blackening. In this context, it can be inferred that if the amount of tungsten halide evaporated can be increased somehow, blackening can be prevented.

It is appropriate to increase the temperature of the bulb wall in order to increase the amount of tungsten halide to be evaporated. Here, the point is that non-uniformity in the temperature of the luminous bulb 1 should be reduced. This is because if the temperature is non-uniform to a large extent, the halogen cycle does not work well, so that blackening seems to occur somewhere in the luminous bulb 1. This will be described further below.

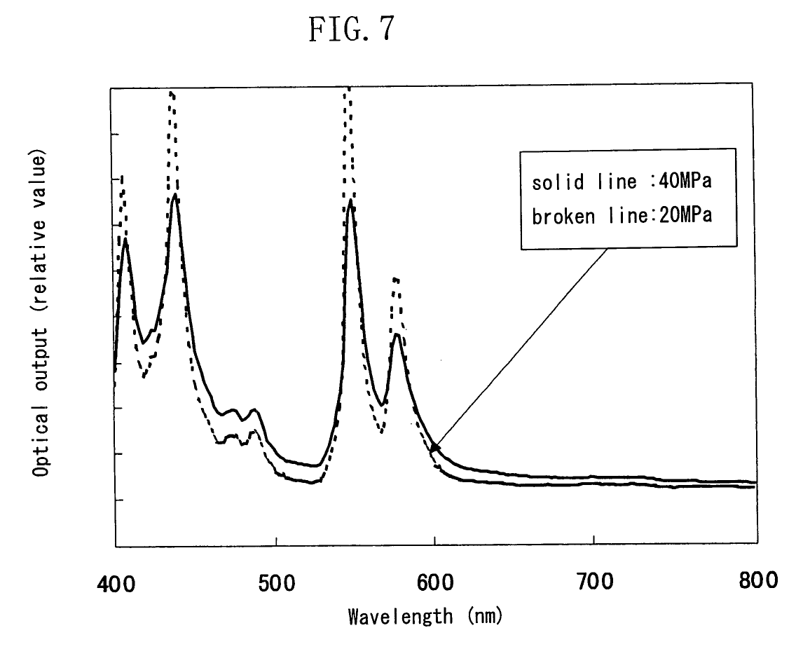

There are two type of temperatures of the luminous bulb 1, that is, heat emitted from the arc that is transmitted through gas in the luminous bulb and the electrodes, and heat generated by the fact that quartz that is the material of the luminous bulb absorbs infrared radiation from the arc. As shown in FIG. 7, the emission spectrum is changed by increasing the amount of mercury in the luminous bulb 1, so that emission in the infrared region is increased. This increase of the infrared radiation raises the temperature of the luminous bulb 1.

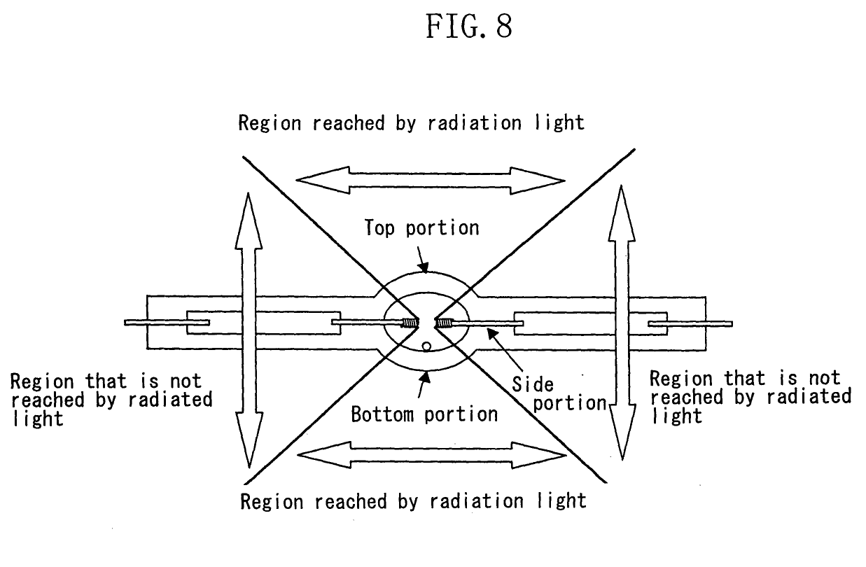

In this case, as shown in FIG. 8, regarding the radiation from the arc, emission (infrared region) reaches directly the top portion and the bottom portion of the luminous bulb 1, and so that the temperature of the luminous bulb is increased. On the other hand, emission does not reach directly the side portion because that portion is behind the electrode. Therefore, the difference in the temperature between the side portion and the top portion or the bottom portion is increased. The results of actually measuring the temperature of each portion of the luminous bulb 1 are shown in Table 1 below.

TABLE 1

| | TOP | SIDE | BOTTOM | non-uniformity in |
|---|---|---|---|---|
| | portion | portion | portion | temperature |
| lamp 100 | 930° C. | 840° C. | 820° C. | 110° C. |
| (40 MPa operation) | | | | |
| Com. Ex. 1 | 920° C. | 700° C. | 780° C. | 220° C. |
| (40 MPa operation) | | | | |
| Com. Ex. 2 | 860° C. | 700° C. | 710° C. | 160° C. |
| (20 MPa operation) | | | | |

As seen from Table 1, comparing the temperature of the lamp of Comparative Example 1 (operating pressure: 40 MPa) with the temperature of the lamp of Comparative Example 2 (operating pressure: 20 MPa), the temperature in the top and bottom portions reached by light emitted in the infrared region is increased by 60 to 70° C., whereas the temperature in the side portion that is not reached by light emitted in the infrared region is not increased. Therefore, the difference between the maximum temperature and the minimum temperature is 860-700=160° C. in the lamp of Comparative Example 2 (operating pressure: 20 MPa), whereas the difference in the temperature is 920-700=220° C. in the lamp of Comparative Example 1 (operating pressure: 40 MPa), which is larger. Consequently, the halogen cycle that caused by halogen enclosed in the luminous bulb did not work well, and thus blackening seems to have occurred.

On the other hand, since the lamp 100 of this embodiment has the heat-retaining film 10, the temperature of the side portion is higher than that of the lamp of Comparative Example 1 (operating pressure: 40 MPa). Therefore, the difference in the temperature of the luminous bulb is 930-820=110° C., and thus the difference in the temperature of the lamp 100 is smaller than that of the lamp of Comparative Example 1 (operating pressure: 40 MPa).

Thus, according to the lamp 100 of this embodiment, the heat-retaining film 10 is formed at least in a portion of the luminous bulb 1 and the sealing portions 2 (in a portion of the sealing portion 2 with a distance L of not more than 10 mm, in particular, a portion with a distance L of more than 0 mm). Therefore, non-uniformity in the temperature of the luminous bulb 1 can be reduced, so that blackening can be suppressed. In a region of the amount of mercury in the conventional superhigh pressure mercury lamp (operating pressure: 20 MPa), radiation in the infrared region is small and does not reach the extent causing non-uniformity in the temperature of the luminous bulb that causes blackening. Accordingly, it would be difficult even for those skilled in the art to conceive the lamp 100 of this embodiment of the present invention based on the knowledge of the conventional superhigh pressure mercury lamp. That is to say, with respect to the problem of blackening that was not observed until the operating pressure was increased to be as high as 30 MPa, it was found that blackening was caused by very large non-uniformity in the temperature of the luminous bulb, and a solution thereof was found. This made it possible to achieve the lamp 100.

The inventors of the present invention confirmed with experiments that such non-uniformity in the temperature becomes large at an operating pressure of 30 MPa or more. However, in order to guarantee that blackening does not occur for a long time with respect to lamps of 30 MPa or less, but more than 20 MPa (i.e., lamps having an operating pressure exceeding the conventional operating pressure of 15 MPa to 20 MPa, for example, lamps of 23 MPa or more or 25 MPa or more), it is desirable in practical use to provide the heat-retaining film 10 to eliminate non-uniformity in the temperature of the luminous bulb 1 to suppress blackening in advance. In other words, in the case of mass production of lamps, there is inevitably a variation in the characteristics of the lamps. Therefore, even if the operating pressure of the lamp is about 23 MPa, one or a few lamps may be blackened, and in order to ensure prevention of blackening, it is preferable to provide the heat-retaining film (heat-retaining means) 10 in the lamps having an operating pressure exceeding the conventional operating pressure of 15 MPa to 20 MPa. It is needless to say that as the operating pressure is larger, in other words, when the operating pressure is 40 MPa rather than 30 MPa, the technical significance of blackening suppression by the heat-retaining film (heat-retaining means) 10 is larger, because the infrared radiation becomes larger and therefore non-uniformity in the temperature of the luminous bulb 1 becomes large, and the effect of blackening is larger.

In this embodiment, the heat-retaining film 10 is formed in the high pressure mercury lamp. The material for the heat-retaining film 10 can be any type, as long as it serves to retain heat. As the material of the heat-retaining film 10, for example, zirconia can be used other than alumina. The form is not limited to a film-like form, and any forms can be used, as long as the heat-retaining effect can be exhibited. As described above, the shortest distance L between the end portion of the heat-retaining film 10 on the luminous bulb side and the border 21 is preferably 10 mm or less. If it exceeds 10 mm, the heat-retaining effect is reduced. Furthermore, the thickness of the heat-retaining film 10 is, for example, about 0.001 to 20 mm, but a thicker film is preferable because the heat-retaining effect is higher. It is preferable to provide the heat-retaining film 10 selectively in a portion that is not reached by radiation shown in FIG. 8 while selecting the position at which the heat-retaining film 10 is provided and the size of the heat-retaining film 10 as appropriate, because the heat-retaining film 10 does not block emitted light. It is more preferable to provide the heat-retaining film 10 only in the sealing portion 2 such that the heat-retaining film 10 does not block the light reflected and emitted from the luminous bulb 1. However, since the heat-retaining effect depends on the design size of the lamp, the material of the heat-retaining film 10, the size of the heat-retaining film 10 and the like, design should be carried out such that non-uniformity in the temperature of the luminous bulb 1 is reduced.

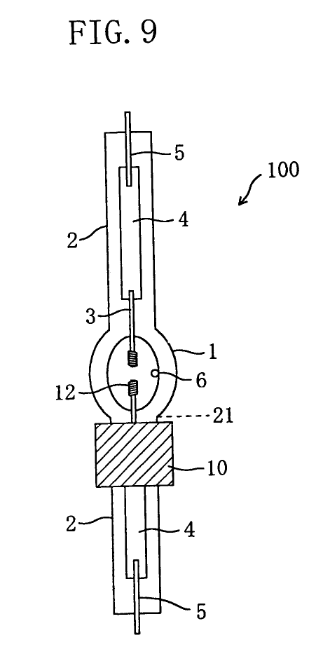

In addition, when the luminous bulb 1 is operated vertically, the temperature of the top portion of the luminous bulb 1 is not increased very much, and an appropriate temperature is maintained also in the side portion by infrared radiation. Then, as shown in FIG. 9, it is possible to retain heat at least in the lower portion of the lamp. In the example shown in FIG. 9, the heat-retaining film 10 can be provided only in the sealing portion 2 that is positioned in the lower portion. In the structure of Embodiment 1, if the effect of suppressing blackening can be obtained, compared with the structure without the heat-retaining film 10, it may be sufficient to provide the heat-retaining film 10 only in one of the sealing portions 2, depending on the cases. Furthermore, the heat-retaining film 10 can be provided in one of the sealing portions 2 and heating means such as a heating wire can be arranged in the other sealing portion 2 in order to eliminate non-uniformity in the temperature of the luminous bulb 1.

Embodiment 2

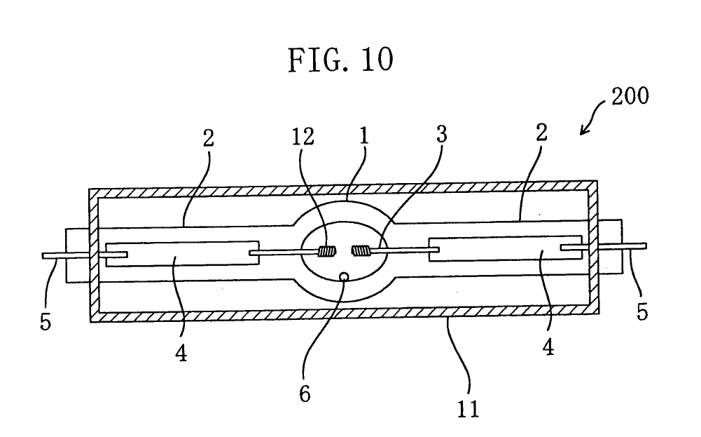

Next, Embodiment 2 of the present invention will be described with reference to FIG. 10. This embodiment has a structure in which an outer tube 11 made of a translucent material is arranged around the luminous bulb 1, instead of the heat-retaining film 10 of Embodiment 1. Other aspects of the structure are the same as in the structure of Embodiment 1, so that description thereof is omitted.

The high pressure mercury lamp 200 of this embodiment shown in FIG. 10 has a structure in which an outer tube 11 made of a translucent material is provided around the luminous bulb 1 of a lamp (e.g., lamps shown in FIGS. 2 to 5) having an amount of enclosed mercury of 230 mg/cm³ or more such that the outer tube 11 is apart from the luminous bulb 1.

The outer tube 11 of this embodiment is made mainly of translucent glass. The outer diameter of the outer tube 11 is about 110 to 200% of the outer diameter of the luminous bulb 1, and the thickness is about 0.3 to 10 mm. The outer tube 11 is not in contact with the luminous bulb 1. It is preferable that an infrared reflecting film is formed in the outer tube 11. In the example shown in FIG. 10, when the outer diameter of the luminous bulb 1 is 10 mm, the outer diameter of the outer tube 11 is 15 mm, and the thickness is 1 mm. An infrared reflecting film is formed in the outer tube 11.

According to the lamp 200 of this embodiment, the outer tube 11 is provided around the luminous bulb 1, so that non-uniformity in the temperature of the luminous bulb 1 that causes blackening can be eliminated, thus preventing blackening from occurring. That is to say, due to the heat-retaining effect of the outer tube 11 and the infrared reflecting film formed in the outer tube 11, non-uniformity in the temperature of the luminous bulb 1 is reduced to allow the halogen cycle to work well, so that blackening can be prevented from occurring. In this case, if a material having a high light transmittance is selected to constitute the outer tube 11, radiation loss can be small.

In the lamp 200 of this embodiment, an example in which an infrared reflecting film is formed in the outer tube 11 is shown, but without the infrared reflecting film, the effect of retaining heat is sufficient. Furthermore, a lamp provided with the heat-retaining film 10 in the sealing portion 2 as in the lamp 100 of Embodiment 1 can be combined with the outer tube 11.

Embodiment 3

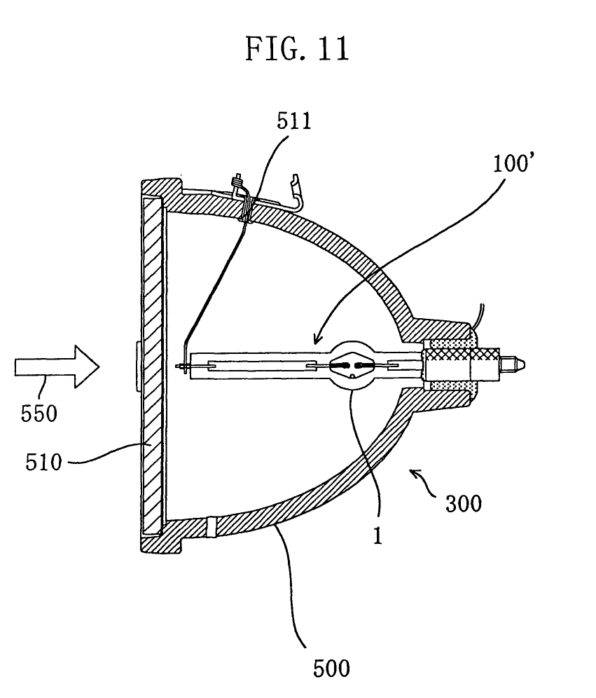

Next, Embodiment 3 will be described with reference to FIG. 11. FIG. 11 schematically shows the structure of a lamp provided with a reflecting mirror (or a lamp unit) 300 of an embodiment of the present invention. The lamp with a reflecting mirror 300 is obtained by incorporating a lamp 100′ (e.g., lamps 1100 to 1500 shown in FIGS. 2 to 5) having an amount of enclosed mercury of 230 mg/cm³ or more into a reflecting mirror 500. That is, the lamp 100′ is different from the lamp 100 of Embodiment 1 in that the heat-retaining film 10 is not provided. The reflecting mirror 500 functions as the heat-retaining means of the luminous bulb 1, and thus non-uniformity in the temperature of the luminous bulb 1 is eliminated to allow the halogen cycle to work well, so that blackening can be prevented from occurring. The reflecting mirror 500 of this embodiment is ellipsoidal or paraboloidal, and a front opening is provided in the light emission direction. A front glass 510 is provided in the front opening, and the reflecting mirror 500 constitutes a substantially airtight structure inside.

In the example shown in FIG. 11, the reflecting mirror 500 is a parabolic mirror, and the area of the radiation surface (an hatched portion in FIG. 11) is 25 cm². The reflecting mirror 500 may be an ellipsoidal mirror. Herein, the area of the radiation surface is the area of a reflection surface viewed from the direction of an arrow 550. The outer shape of the reflecting mirror 500 of this embodiment that is viewed from the direction of an arrow 550 is a square, and the size thereof is 5 cm x 5 cm. The outer shape is not necessarily a square and can be a circle.

A front glass 510 is attached to the front surface of the reflecting mirror 500, and the reflecting mirror 500 is an airtight type in which a ventilation hole is not provided so that air does not enter from the outside of the reflecting mirror 500 during lamp operation. The high pressure mercury lamp 100′ is fixed to the base of the reflecting mirror 500 with cement and is supplied with current through a lead 511.

When the lamp shown in FIG. 11 (an amount of enclosed mercury: 400 mg/cm³) was operated at a rated power of 120W, blackening was not observed. This seems to be because non-uniformity in the temperature of the luminous bulb 1 is reduced by the fact that heat in the lamp 100′ is retained by incorporating the lamp 100′ into the airtight type reflecting mirror 500. This embodiment has a structure in which the front glass 510 is provided and the reflecting mirror 500 is not provided with a ventilation hole, so that the heat-retaining effect is enhanced.

Although it is an airtight type, in reality, it is necessary to open a very small hole in the reflecting mirror 500 for inevitable purposes such as providing a lead for interconnection. In this embodiment, if the area of the hole is 1 cm² or less in total, there is substantially no cooling effect, and the presence of such a hole can be allowed and the inside of the reflecting mirror 500 can be considered to be substantially airtight.

The heat-retaining effect is determined by the correlation between the rated power (W) of the lamp, which generates heat, and the size (radiation area) of the reflecting mirror, which retains heat. That is to say, it is preferable to combine a lamp having small heat generation with a small reflecting mirror that can be provided closer to the lamp so that the heat-retaining effect can be large. There is the following relationship when the size of the reflecting mirror 500 is represented by the area of the radiation surface. In the case where the rated power of the lamp during stable operation is about 60 to 120 W, it is preferable that the radiation area of the reflecting mirror is 25 cm² or less. In the case of a lamp having a rated power of about 121 to 200 W, it is preferable that the radiation area of the reflecting mirror is 40 cm² or less. In the case of a lamp having a rated power of about 201 to 350 W, it is preferable that the radiation area of the reflecting mirror is 55 cm² or less.

It is possible to combine the structure of this embodiment and the structure of Embodiment 1 and/or Embodiment 2. In other words, the heat-retaining film 10 may be formed in the sealing portion 2 in the lamp 100′, or the outer tube 11 may be provided therein. Since the blackening of the high pressure mercury lamp is a problem that has to be avoided in lamps having an operating pressure exceeding 15 MPa to 20 MPa of the conventional lamps, the lamp 200 is not only the lamps 1100 to 1500 shown in FIGS. 2 to 5, but also may be lamps having an operating pressure exceeding 20 NPa that have excellent high withstand pressure characteristics (e.g., lamps of 23 MPa or more, in particular, 30 NPa or more). According to this embodiment, blackening can be suppressed by controlling non-uniformity in the temperature of the lamp. However, excessive heat retention may cause swelling of the luminous bulb or devitrification, so that it is preferable to set it in an appropriate range.

The blackening in Embodiments 1 to 3 are also affected by the relationship between the halogen density and the temperature of the luminous bulb, and therefore, for example, when CH₂Br₂ is selected as the halogen to be enclosed, it is preferable to enclose it in an amount of about 0.0017 to 0.17 mg/cc based on the internal volume of the luminous bulb. If this preferable amount is represented based on the halogen atom density, it is about 0.01 to 1 μmol/cc. This is because if the amount is less than 0.01 μmol/cc, the major part of the halogen reacts with impurities in the lamp, which substantially prevents the halogen cycle from occurring. If the amount is more than 1 μmol/cc, a pulse voltage necessary for start-up becomes higher and this is not practical. However, when a ballast that can apply a high voltage is used, this limitation is not applied. It is more preferable that the amount is 0.1 to 0.2 μmol/cc, because even if there is more or less a variation in the amount of the enclosed halogen due to various situations during production, the halogen cycle can work well in this range.

In the lamps of Embodiments 1 to 3, if the bulb wall load is 80 W/cm² or more, the temperature of the bulb wall of the luminous bulb is increased sufficiently, so that all the enclosed mercury evaporates, and therefore the following approximate expression is satisfied: the amount of mercury per internal volume in the luminous bulb: 400 mg/cc=the operating pressure during operation: 40 MPa. Here, if the amount of mercury is 300 mg/cc, the operating pressure is 30 MPa during operation. On the other hand, if the bulb wall load is less than 80 W/cm², the temperature of the luminous bulb cannot be increased sufficiently to evaporate the mercury, and therefore the approximate expression may not be satisfied. In the case of less than 80 W/cm², a desired operating pressure often cannot be obtained, and in particular, light emission in the infrared region is small, and the lamp is not suitable as a light source for projectors.

An image projecting apparatus can be configured by combining the high pressure mercury lamp of the above-described embodiments or the lamp unit (lamps provided with a reflecting mirror) and an optical system including a picture element (such as DMD (Digital Micromirror Device) panel or a liquid crystal panel). For example, a projector using DM1 (digital light processing (DLP) projector) and a liquid crystal projector (including a reflecting projector employing an LCOS (Liquid Crystal on Silicon) structure) can be provided. Furthermore, the lamp of the embodiments of the present invention can be used preferably, not only as a light source of an image projecting apparatus, but also for other applications, such as a light source for ultraviolet ray steppers or a light source for sport stadium, a light source for automobile headlights, and a floodlight for illuminating traffic signs.

The present invention has been described by way of preferable embodiments, but the above-description is not limiting and various modifications can be made.

Although the structure is different from that of the lamps of the embodiments of the present invention, Japanese Laid-Open Patent Publication No. 7-230791 discloses a metal halide lamp in which a heat-retaining film is applied. In the lamp disclosed in this publication, a heat-retaining film is applied to an end portion of a luminous bulb of a metal halide lamp to adjust the temperature of the portion having the coldest temperature in the luminous bulb, so that the metal halide is sufficiently evaporated and emission is improved. The lamp disclosed in this publication and the lamp of the embodiments of the present invention are different in the type of the lamp and the purpose and the effect. The high pressure mercury lamp of this embodiment suppresses blackening by controlling the temperature of the luminous bulb, and this feature is not described or suggested in Japanese Laid-Open Patent Publication No. 7-230791.

According to the present invention, even a high pressure mercury lamp having an operating pressure of 20 MPa or more (e.g., 23 MPa or more, in particular 25 MPa or 30 MPa or more) can be operated while blackening can be suppressed.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

The entire content of Priority Document No. 2002-186511 is incorporated herein by reference.

What is claimed is:

1. A high pressure mercury lamp comprising a luminous bulb in which at least mercury is enclosed inside the bulb, and a pair of sealing portions that retain airtightness of the luminous bulb,
wherein at least one of the sealing portions has a first glass portion extending from the luminous bulb and a second glass portion provided at least in a portion inside the first glass portion, and the one of the sealing portions has a portion to which a compressive stress is applied, and
a heat-retaining film made of an insulating material or a heat-retaining material is provided at least in a portion of the luminous bulb and the pair of sealing portions.

2. The high pressure mercury lamp according to claim 1, wherein an amount of the enclosed mercury is 230 mg/cm³ or more based on a volume of the luminous bulb.

3. The high pressure mercury lamp according to claim 1, wherein
an amount of the enclosed mercury is 300 mg/cm³ or more based on a volume of the luminous bulb,
halogen is enclosed in the luminous bulb, and
a bulb wail load of the high pressure mercury lamp is 80 W/cm² or more.

4. The high pressure mercury lamp according to claim 1, wherein
the heat-retaining film is not formed in the luminous bulb, and formed at least in one of the pair of sealing portions, and
an end face of the heat-retaining film on a side of the luminous bulb is positioned apart from a border between the at least one of the sealing portions and the luminous bulb by 1 mm or more.

5. The high pressure mercury lamp according to claim 4, wherein
the end face of the heat-retaining film on the side of the luminous bulb is positioned within 10 mm from the border.

6. The high pressure mercury lamp according to claim 1, wherein
the heat-retaining film is made of alumina.

7. A high pressure mercury lamp comprising a luminous bulb in which at least mercury is enclosed inside the bulb, and a pair of sealing portions that retain airtightness of the luminous bulb,
wherein at least one of the sealing portions has a first glass portion extending from the luminous bulb and a second glass portion provided at least in a portion inside the first glass portion, and the one of the sealing portions has a portion to which a compressive stress is applied, and
an outer tube made of a translucent material is provided around the luminous bulb such that the outer tube is apart from the luminous tube.

8. The high pressure mercury lamp according to claim 7, wherein
an infrared reflecting film is formed in the outer tube.

9. The high pressure mercury lamp according to claim 1 or 7, wherein
a pair of electrode rods are opposed to each other in the luminous bulb,
at least one of the pair of electrode rods is connected to a metal foil, and
the metal foil is provided in the sealing portion, and at least a portion of the metal foil is positioned in the second glass portion.

10. The high pressure mercury lamp according to claim 9, wherein
a coil having at least one metal selected from the group consisting of Pt, Ir, Rh, Ru, and Re at least on its surface is wound around at least in a portion of the electrode rod that is buried in the at least one of the sealing portions.

11. The high pressure mercury lamp according to claim 1 or 7, wherein
a metal portion that is in contact with the second glass portion and supplies power is provided in the sealing portions,
the compressive stress is applied at least in a longitudinal direction of the sealing portions,
the first glass portion contains 99 wt % or more of SiO₂, and
the second glass portion contains SiO₂ and at least one of 15 wt % or less of Al₂O₃ and 4 wt % or less of B.

12. A high pressure mercury lamp comprising a luminous bulb in which at least mercury is enclosed inside the bulb and a pair of electrode rods are opposed, and a pair of sealing portions extending from the luminous bulb, wherein
a coil having at least one metal selected from the group consisting of Pt, Ir, Rh, Ru, and Re at least on its surface is wound around at least in a portion of the electrode rod that is buried in at least one of the sealing portions, and
a heat-retaining film made of an insulating material or a heat-retaining material is formed at least in a portion of the luminous bulb and the pair of sealing portions.

13. A high pressure mercury lamp comprising a luminous bulb in which at least mercury is enclosed inside the bulb, and a pair of sealing portions that retain airtightness of the luminous bulb, wherein
an amount of the enclosed mercury is 230 mg/cm³ or more based on a volume of the luminous bulb, and
the high pressure mercury lamp further comprising heat-retaining means for retaining heat in the luminous bulb.

14. The high pressure mercury lamp according to claim 13, wherein
the heat-retaining means is a heat-retaining film that is formed at least in a portion of the luminous bulb and the pair of sealing portions, and is made of an insulating material or a heat-retaining material.

15. The high pressure mercury lamp according to claim 13, wherein
the heat-retaining means is an outer tube that is provided around the luminous bulb such that the outer tube is apart from the luminous bulb, and is made of a translucent material.

16. The high pressure mercury lamp according to any one of claims 10 or 12, wherein
an amount of the enclosed mercury is 300 mg/cm³ or more based on a volume of the luminous bulb,
halogen is enclosed in the luminous bulb, and
a bulb wall load of the high pressure mercury lamp is 80 W/cm² or more.

17. A lamp unit comprising a high pressure mercury lamp and a reflecting mirror for reflecting light emitted from the high pressure mercury lamp,
the high pressure mercury lamp comprising a luminous bulb in which at least mercury is enclosed inside the bulb, and a pair of sealing portions that retain airtightness of the luminous bulb,
wherein an amount of the enclosed mercury is 230 mg/cm³ or more based on a volume of the luminous bulb, and
heat-retaining means for retaining heat in the luminous bulb is provided.

18. The lamp unit according to claim 17, wherein
the heat-retaining means is a heat-retaining film that is formed at least in a portion of the luminous bulb and the pair of sealing portions, and is made of an insulating material or a heat-retaining material.

19. The lamp unit according to claim 17, wherein
the reflecting mirror is an ellipsoidal or paraboloidal reflecting mirror having a front opening in an emission direction,
a front glass is provided in the front opening,
the inside of the reflecting mirror is substantially airtight, and
the reflecting mirror serves as the heat-retaining means.

20. The lamp unit according to claim 19, wherein
an amount of the enclosed mercury is 300 mg/cm³ or more based on a volume of the luminous bulb,
halogen is enclosed in the luminous bulb, and
a bulb wall load of the high pressure mercury lamp is 80 W/cm² or more.

21. The lamp unit according to claim 20, wherein
the reflecting mirror has a structure in which a side face of the reflecting mirror is not provided with a ventilation hole,
a size of a radiation surface of the reflecting mirror is 25 cm² or less, and
a wattage of the high pressure mercury lamp during steady operation is 60 W or more and 120 W or less.

22. The lamp unit according to claim 20, wherein
the reflecting mirror has a structure in which a side face of the reflecting mirror is not provided with a ventilation hole,
a size of a radiation surface of the reflecting mirror is 40 cm² or less, and
a wattage of the high pressure mercury lamp during steady operation is 121 W or more and 200 W or less.

23. The lamp unit according to claim 20, wherein
the reflecting mirror has a structure in which a side face of the reflecting mirror is not provided with a ventilation hole,
a size of a radiation surface of the reflecting mirror is 55 cm² or less, and
a wattage of the high pressure mercury lamp during steady operation is 201 W or more and 350 W or less.
